(19) United States
(12) Patent Application Publication
(10) Pub. No.: US 2014/0267004 A1
(43) Pub. Date: Sep. 18, 2014

(54) User Adjustable Gesture Space

(71) Applicant: LSI CORPORATION, San Jose, CA (US)

(72) Inventor: Barrett J. Brickner, Savage, MN (US)

(73) Assignee: LSI CORPORATION, San Jose, CA (US)

(21) Appl. No.: 13/828,126

(22) Filed: Mar. 14, 2013

Related U.S. Application Data
(60) Provisional application No. 61/778,769, filed on Mar. 13, 2013.

(51) Int. Cl. G06F 3/01

(52) U.S. Cl. CPC G06F 3/017
USPC 345/156

(57) ABSTRACT

A method for adjusting an active area of a sensor's field of view by recognizing a touch-less adjust gesture. The method includes receiving data from a sensor having a field of view. The method also includes performing at least one gesture recognition operation upon receiving data from the sensor. The method additionally includes recognizing an adjust gesture by a user. The adjust gesture is a touch-less gesture performed in the field of view by the user to adjust the active area of the field of view. The method further includes adjusting the active area in response to recognizing the adjust gesture by the user.

### CROSS-REFERENCE TO RELATED APPLICATIONS

This application claims the benefit of U.S. Provisional Application No. 61/778,769, filed on Mar. 13, 2013.

### FIELD OF THE INVENTION

Embodiments of the invention are directed generally toward a method, circuit, apparatus, and system for human-machine interfaces where control and navigation of a device is performed via movements of a user in free space.

### BACKGROUND

Existing gesture recognition systems operate with gesture areas which require that the camera's field of view be adjusted by manually positioning a camera or zooming a lens of the camera. As such, adjusting the orientation and size of a camera's gesture area in existing gesture recognition systems is inconvenient, time consuming, and requires repetitive manual adjustment. Therefore, it would be desirable to provide a method, system, and apparatus configured to overcome the requirement to manually adjust orientation and size of gesture areas of gesture recognition systems.

### SUMMARY

Accordingly, an embodiment includes a method for adjusting an active area of a sensor's field of view by recognizing a touch-less adjust gesture. The method includes receiving data from a sensor having a field of view. The method also includes performing at least one gesture recognition operation upon receiving data from the sensor. The method additionally includes recognizing an adjust gesture by a user. The adjust gesture is a touch-less gesture performed in the field of view by the user to adjust the active area of the field of view. The method further includes adjusting the active area in response to recognizing the adjust gesture by the user.

Additional embodiments are described in the application including the claims. It is to be understood that both the foregoing general description and the following detailed description are exemplary and explanatory only and are not restrictive. Other embodiments of the invention will become apparent.

### BRIEF DESCRIPTION OF THE FIGURES

Other embodiments of the invention will become apparent by reference to the accompanying figures in which:

FIG. 1A shows a diagram of an exemplary computing device configured to perform embodiments of the invention;

FIG. 1B shows a diagram of an exemplary system which includes a further exemplary computing device configured to perform embodiments of the invention;

FIG. 2A shows an exemplary configuration of an active gesture area in a field of view of a sensor;

FIG. 2B shows the active gesture area (depicted in FIG. 2A) being adjusted within the field of view of the sensor;

FIG. 3 shows an exemplary adjustment to at least one active area based upon one or more adjust gestures of at least one user;

FIG. 4 shows an additional exemplary adjustment to at least one active area based upon one or more adjust gestures of at least one user;

FIG. 5 shows a further exemplary adjustment to at least one active area based upon one or more adjust gestures of at least one user;

FIG. 6 shows an exemplary sensor field of view image; and

FIG. 7 shows a method of embodiments of the invention.

### DETAILED DESCRIPTION OF THE INVENTION

Reference will now be made in detail to the subject matter disclosed, which is illustrated in the accompanying drawings. The scope of embodiments of the invention is limited only by the claims; numerous alternatives, modifications, and equivalents are encompassed. For the purpose of clarity, technical material that is known in the technical fields related to the embodiments has not been described in detail to avoid unnecessarily obscuring the description.

Embodiments of the invention include a method, apparatus, circuit, and system for selecting and adjusting the position, orientation, shape, dimensions, curvature, and/or size of one or more active areas for gesture recognition. Embodiments include gesture recognition processing to adjust the active area within the field-of-view without requiring a physical adjustment of a camera position or lens.

Embodiments of the invention include a gesture recognition system implemented with a touch-less human-machine interface (HMI) configured to control and navigate a user interface (such as a graphical user interface (GUI)) via movements of the user in free space (as opposed to a mouse, keyboard, or touch-screen). Embodiments of the invention include touch-less gesture recognition systems which respond to gestures performed within active areas of one or more fields of view of one or more sensors, such as one or more optical sensors (e.g., one or more cameras). In some embodiments, the gestures include gestures performed with one or some combination of at least one hand, at least one finger, a face, a head, at least one foot, at least one toe, at least one arm, at least one eye, at least one muscle, at least one joint, or the like. In some embodiments, particular gestures recognized by the gesture recognition system include finger movements, hand movements, arm movements, leg movements, feet movement, face movement, or the like. Furthermore, embodiments of the invention include the gesture recognition system being configured to distinguish and respond differently for different positions, sizes, speeds, orientations, or the like of movements of a particular user.

Embodiments include, but are not limited to, adjusting an orientation or position of one or more active areas, wherein each of the one or more active areas includes a virtual surface or virtual space, within free space of at least one field of view of at least one sensor. For example, in some implementations at least one field of view of at least one sensor is a field of view of one sensor, a plurality of fields of view of a plurality of sensors, or a composite field of view of a plurality of sensors. Embodiments of the invention include adjusting active areas via any of a variety of control mechanisms. In embodiments of the invention, a user can perform gestures to initiate and control the adjustment of the active area. Some embodiments of the invention use gesture recognition processing to adjust one or more active areas within the field-of-view of a particular sensor (e.g., a camera) without adjustment of the particular sensor's position, orientation, or lens. While some embodiments are described as having one or more optical sensors, other embodiments of the invention include other types of sensors, such as non-optical sensors, acoustical sensors, proximity sensors, electromagnetic field sensors, or the like. For example, some embodiments of the invention include one or more proximity sensors, wherein the proximity sensors detect disturbances to an electromagnetic field. By further example, other embodiments include one or more sonar-type (SOund Navigation And Ranging) sensors configured to use acoustic waves to locate surfaces of a user's hand. For particular embodiments which include one or more non-optical sensors, a particular non-optical sensor's field of view refers to a field of sense (i.e., the spatial area over which the particular non-optical sensor can operatively detect).

Further embodiments of the invention allow adjustment of the active area for convenience, ergonomic consideration, and reduction of processing overhead. For example, adjusting the active area can include reducing, enlarging, moving, rotating, inverting, stretching, combining, splitting, hiding, muting, bending, or the like of part or all of the active area. Adjusting the active area, which includes, for example, reducing the active area relative to the total field of view, can improve a user's experience by rejecting a greater number of spurious or unintentional gestures which occur outside of the active area. Additionally, upon reducing the active area relative to the total field of view, a gesture recognition system requires fewer processor operations to handle a smaller active area.

Various embodiments of the invention include any (or some combination thereof) of various gesture recognition implementations. For example, in some embodiments, a docking device for a portable computing device (such as a smart phone, a laptop computing device, or a tablet computing device) includes a projector to display the image from the portable computing device onto a wall or screen or includes a video or audio/video output for outputting video and/or audio to a display device. A user can bypass touch-based user input controls (such as a physical keyboard, a mouse, a track-pad, or a touch screen) or audio user input controls (such as voice-activated controls) to control the portable computing device by performing touch-less gestures in view of at least one sensor (such as a sensor of the portable computing device, one or more sensors of the dock, one or more sensors of one or more other computing devices, one or more other sensors, or some combination thereof). In some embodiments, the touch-less gesture controls can be combined with one or more of touch-based user input controls, audio user input controls, or the like. In this embodiment the gesture recognition system responds to gestures equivalent to the touch screen made in a plane located above the projector. Users can perform touch-less gestures to adjust one or more of the size, position, sensitivity, or orientation of the virtual plane to accommodate different physical characteristics of various users. For example, in some embodiments, the gesture recognition system can adjust the active area for particular physical characteristics such as user body features (such as height or body shape), user posture (such as various postures of sitting, laying, or standing), non-gesture user movements (such as walking, running, or jumping), spurious gestures, outerwear (such as gloves, hats, shirts, pants, shoes, or the like), or other inanimate objects (such as hand-held objects). In some embodiments, the gesture recognition system automatically adjusts the active area based upon detected physical characteristics of a particular user or users; in other embodiments, the gesture recognition system responsively adjusts the active area based upon a detection of a performance of a particular gesture by a user.

Embodiments include a method for adjustment of an active area by recognizing a gesture within in a sensor's field-of-view, whereby the gesture is not a touch screen gesture.

Referring to FIG. 1A, a block diagram of an exemplary computing device 100 suitable for implementation as a gesture recognition system of embodiments of the invention is depicted. In some embodiments, the computing device 100 includes at least one sensor 110, at least one processor 120, a display/projector 130, as well as other components, software, firmware, or the like. For example, in some implementations of embodiments of the invention, the computing device 100 further includes one or more of the following components: a circuit board, a bus, memory (such as memory 140 shown in FIG. 1B), storage, a network card, a video card, a wireless antenna, a power source, ports, or the like. In some embodiments, the computing device 110 comprises a portable computing device (such as a smart phone, tablet computing device, laptop computing device, a wearable computing device, or the like), while in other embodiments the computing device 100 comprises a desktop computer, a smart television, or the like. In still other embodiments, the computing device 100 is a display device (such as display device 130A shown in FIG. 1B), such as a television or display. In some embodiments, the at least one processor 120 is configured to process images or data received from the at least one sensor 110, output processed images to the display/projector 130, perform gesture recognition processing and/or other methods of embodiments of the invention; in other embodiments, another processing module, controller, or integrated circuit is configured to perform gesture recognition processing and/or other methods of embodiments of the invention.

Referring to FIG. 1B, a block diagram of a further exemplary gesture recognition system of embodiments of the invention is depicted. According to FIG. 1B, the further exemplary gesture recognition system includes a plurality of communicatively coupled computing devices, including at least one sensor device 110A, at least one computing device 100, and at least one display device 130A. According to FIG. 1B, in some embodiments the at least one sensor device 110A is configured to capture image data via at least one sensor 110 and send image data to the at least one computing device 100; the at least one computing device 100 is configured to receive image data from the at least one sensor device 110A, perform gesture recognition processing on image data from the at least one sensor device 110A, and output the image data to the at least one display device 130A to be displayed. In some embodiments, the further exemplary gesture recognition system includes additional devices or components, such as a networking device (e.g., a router, a server, or the like) or other user input devices (e.g., a mouse, a keyboard, or the like). In some implementations of embodiments of the invention, the computing device 100 further includes one or more of the following components: a circuit board, a bus, memory, storage, a network card, a video card, a wireless antenna, a power source, ports, or the like. In some embodiments, the at least one computing device 100 comprises a portable computing device (such as a smart phone, tablet computing device, laptop computing device, a wearable computing device, or the like), while in other embodiments the computing device 100 comprises a desktop computer, smart television, docking device for a portable computing device, or the like.

Still referring to FIG. 1B, in some embodiments, the at least one sensor device 110A is one or more optical sensors devices communicatively coupled to the computing device 100; in these embodiments, each of the at least one sensor device 110A includes at least one sensor 110; in other embodiments, the at least one sensor device 110A can comprise another computing device (separate from the computing device 100) which includes a sensor 110. In further embodiments of the invention, the sensor device 110A includes other computing or electronic components, such as a circuit board, a processor, a bus, memory, storage, a display, a network card, a video card, a wireless antenna, a power source, ports, or the like.

Still referring to FIG. 1B, in some embodiments, the at least one display device 130A is communicatively coupled to the computing device 100, wherein the display device 130A includes at least one display/projector 130 configured to display or project an image or video. For example, in some embodiments, the display device 130A is a television or computer display. In further embodiments of the invention, the display device 110A includes other computing or electronic components, such as a circuit board, a processor, a bus, memory, storage, a network card, a video card, a wireless antenna, a power source, ports, or the like.

In exemplary embodiments, a gesture recognition system is configured for performing control operations and navigation operations for a display device 130A (such as a television) in response to hand or finger gestures of a particular or multiple users. In some exemplary embodiments, the gesture recognition system is attached to the display device, connected to the display device, wirelessly connected with the display device, implemented in the display device, or the like, and one or more sensors are attached to the display device, connected to the display device, wirelessly connected to the display device, implemented in the display device, or the like. For example, in a particular exemplary embodiment, a television includes a gesture recognition system, display, and a sensor. In the particular exemplary embodiment, the sensor of the television is a component of the television device, and the sensor has a field-of-view configured to detect and monitor for gestures within one or more active areas from multiple users. In some embodiments, the active area allows the particular user to touch-lessly navigate an on-screen keyboard or move an on-screen cursor, such as through a gesture of moving a fingertip in the active area.

In some embodiments, a user performs specific gestures within an active area 210 to perform control operations. For example, in particular embodiments, the active area 210 comprises a variable or fixed area around the user's hand. For example, where the active area 210 comprises a variable area, the size, orientation, and position of the active area 210 (such as an active surface or active space) can be adjusted. As an example of the active area 210 comprising an adjustable active surface or active space, during the adjustment, the user can perform a gesture to define the boundaries of the active area 210. In some embodiments, the active area 210 includes one or more adjustable attributes, such as size, position, or the like. For example, in particular embodiments, the user can perform a hand gesture to define the boundaries of the active area 210 by positioning his or her hands to define the boundaries as a polygon (such as edges of a quadrilateral (e.g., a square, rectangle, parallelogram, or the like), a triangle, or the like) or as a two-dimensional or three-dimensional shape (such as a circle, an ellipse, semi-circle, a parallel-piped, a sphere, a cone, or the like) defined by a set of one or more curves and/or straight lines. For example, the user can define the active area 210 by positioning and/or moving his or her hands in free space (i.e., at least one, some combination, or some sequential combination of one hand left or right, above or below, and/or in front of or behind the other hand) to define the edges or boundaries of a three-dimensional space defined by a set of one or more surfaces (such as planar surfaces or curved surfaces) and/or straight lines. In some embodiments, the adjustment of the active area 210 can be according to a fixed or variable aspect ratio.

Referring to FIGS. 2A-2B, exemplary implementations of embodiments of the invention are depicted. A computing device 100 of the exemplary implementations includes an optical sensor 110 and a projector 130, and the computing device 100 is configured to perform gesture recognition processing to adjust an active gesture area 210 of a field of view 220 of the sensor based upon an adjust gesture of a particular user.

Referring to FIG. 2A, an exemplary implementation is shown for adjusting an active gesture area 210 of embodiments of the invention, which include recognizing a gesture to position the active area 210 relative to a portion of the user's body (such as a particular hand, finger, or fingertip). For example, when the gesture recognition system is activated, reactivated, enabled, re-enabled, or the like (such as when the system is first powered on, resumes operation from an idle state or standby, wakes up from sleep, switches users, switches primary users, adds a user or the like), a particular user holds out an extended finger in the field of view 220 of a sensor 110 of the computing device 100 for a predetermined period of time. Upon recognition of this particular gesture, the gesture recognition system would then position the active area 210 in relation to the user's finger (such as centered about the user's finger).

Referring to FIG. 2B, an exemplary implementation is shown for adjusting an active gesture area 210 of embodiments of the invention, which include recognizing a gesture to position or orient the active area 210 based upon a gesture of a particular user. An exemplary gesture of some embodiments includes two hands of a user virtually grasping at least one portion (e.g., edges, vertices, or the like) of a virtual surface (e.g., a virtual plane or virtual curved surface) of the active area 210. Recognition of the exemplary grasping gesture by the gesture recognition system initiates an adjustment mode during which the virtual surface can be resized, reoriented, or repositioned by relative movement of the user's hand or hands. For example, moving the two hands further apart would increase the size of the virtual surface of the active area 210, moving the hands up or down would adjust the vertical position, and extending one hand forward while pulling one hand back would rotate the virtual surface around an axis (e.g., a vertical axis, a horizontal axis, or an axis having some combination of vertical and horizontal components). While the exemplary grasping gesture initiation and sequences for performing the adjustment of an active area are described, it is fully contemplated that any number or variations of other gestures can be implemented in other embodiments of the invention. In some embodiments, the user can view a display 130 to see a visualized result of the adjustment of the active area 210 as an adjust gesture is performed.

Furthermore, in some embodiments, the gesture recognition system or a component of the gesture recognition system includes a user feedback mechanism to indicate to the user that the adjustment mode has been selected or activated. In some implementations, the user feedback mechanism is displayed visually (such as on a display, on a projected screen (such as projected display 230), by illuminating a light source (such as a light emitting diode (LED)), or the like), audibly (such as by a speaker, bell, or the like), or the like. In some embodiments a user feedback mechanism configured for such an indication allows the user to cancel the adjustment mode. For example, the adjustment mode can be canceled or ended by refraining from performing another gesture for a predetermined period of time, by making a predetermined gesture that positively indicates the mode should be canceled, performing a predetermined undo adjustment gesture configured to return the position and orientation of the active area to a previous or immediately previous position and orientation of the active area, or the like. Additionally, the adjustment mode can be ended upon recognizing the completion of an adjust gesture. By further example, in the case where there is a video output user feedback, a visual overlay on a screen may use words or graphics to indicate that the adjustment mode has been initiated. The user can cancel the adjustment mode by performing a cancel adjustment gesture, such as waving one or both hands in excess of a predetermined rate over, in front of, or in view of the sensor.

Referring now to FIGS. 3-5, additional exemplary adjust gesture operations of some embodiments of the invention are depicted. FIG. 3 depicts multiple users concurrently performing adjust gestures to alter the positions and orientations of each of the multiple user's active areas 210A, 210B within the field of view 220 of at least one sensor 110. FIG. 4 depicts a user performing an adjust gesture to adjust an active area 210 which is a three-dimensional virtual space within the field of view 220 of at least one sensor 110. FIG. 5 depicts a user performing an adjust gesture to enlarge a size of an active area 210. While FIGS. 3-5 depict exemplary adjust gestures of some embodiments of the invention, it is fully contemplated that any number or variations of other gestures can be implemented in other embodiments of the invention.

Referring now to FIG. 6, an exemplary sensor field of view image 610 captured by a sensor 110 of embodiments of the invention is depicted. The exemplary sensor field of view image 610 represents an example of an image captured by a particular sensor 110. In embodiments of the invention, the sensor field of view image 610 includes a plurality of pixels associated with a field of view 220 of the particular sensor 110. In some embodiments, a portion of the plurality of pixels of the sensor field of view image 610 includes a region of pixels associated with at least one active gesture area. For example, a previous active area image portion 621 of the sensor field of view image 610 includes a region of pixels associated with a previous active area; and a current adjusted active area image portion 622 of the sensor field of view image 610 includes a region of pixels associated with a current adjusted active area.

Embodiments of the gesture recognition system perform gesture recognition processing on all or portions of a stream of image data received from the at least one sensor 110. Embodiments include the gesture recognition system performing a cropping algorithm on the stream of image data. In some embodiments performing the cropping algorithm crops out portions of the stream of image data which correspond to areas of the field of view which are outside of the current active gesture area. In some embodiments, based on the resultant stream of image data from performing the cropping algorithm, the gesture recognition system only performs gesture recognition processing on the cropped stream of image data corresponding to the current adjusted active area image portion 622. In other embodiments, the gesture recognition system performs concurrent processes of gesture recognition processing on at least one uncropped stream of image data and at least one cropped stream of image data. In some of the other embodiments, performing concurrent processes of gesture recognition processing on at least one uncropped stream of image data and at least one cropped stream of image data allows the gesture recognition system to perform coarse gesture recognition processing on at least one uncropped stream of image data to recognize gestures having larger motions and to perform fine gesture recognition processing on at least one cropped stream of image data to detect gestures having a smaller motions. Furthermore, in some of the other embodiments, performing concurrent processes of gesture recognition processing allows the system to allocate different levels of processing resources to recognize various sets of gestures or various active areas. Embodiments which include performing the cropping algorithm before or during gesture recognition processing allows the gesture recognition system to reduce the amount of image data to process and allows the gesture recognition system to reduce the processing of spurious gestures which are performed by a particular user outside of the active area.

In some embodiments, an active area can be positioned at least a predetermined distance away from a particular body part of a particular user. For example, the active area can be positioned at least a predetermined distance away from the particular user's head to improve the correct rejection of spurious gestures. Under this example, the active area being positioned a predetermined distance away from the particular user's head reduces the occurrence of false positive gestures which could be caused by movement of the particular user's head within the field-of-view 220. In other embodiments, the active area 210 includes a particular user's head, wherein a gesture includes motion of the head or face or includes a hand or finger motion across or in proximity to the head or the face. In still additional embodiments, an active area 210 includes a particular user's head, and the gesture recognition system is configured to filter out spurious gestures (which in particular embodiments include head movements or facial expressions).

Further embodiments include one or more gesture recognition systems configured to operate with multiple sensors (e.g., multiple optical sensors), multiple displays, multiple communicatively coupled computing devices, multiple concurrently running applications, or the like. Some embodiments include one or more gesture recognition systems configured to simultaneously, approximately simultaneously, concurrently, approximately concurrently, non-concurrently, or sequentially process gestures from multiple users, multiple gestures from a single user, multiple gestures from each user of a plurality of users, or the like. In a particular exemplary embodiment, a gesture recognition system is configured to process concurrent gestures from a particular user, and the particular user can perform a particular gesture to center the active area on the particular user while the particular user performs an additional gesture to define a size and position of the active area. As an additional example, other exemplary embodiments include a gesture recognition system configured to simultaneously, concurrently, approximately simultaneously, approximately concurrently, non-concurrently, or sequentially process multiple gestures from each of a plurality of users, wherein a first particular user can perform a first particular gesture to center a first particular active area on the first particular user while a second particular user performs a second particular gesture to center a second particular active area on the second particular user. Embodiments allow for user preference and comfort through touch-less adjustments of the active area; for example, one user may prefer a smaller active area that requires less movement to navigate, and a second user may prefer a larger area that is less sensitive to tremors or other unintentional movement of the hand or fingers.

Referring now to FIG. 7, an embodiment of the invention includes a method 700 for adjusting an active area of a sensor's field of view by recognizing a touch-less adjust gesture. It is contemplated that embodiments of the method 700 can be performed by a computing device 100; at least one component, integrated circuit, controller, processor 120, or module of the computing device 100; software or firmware executed on the computing device 100; other computing devices (such as a display device 130A or a sensor device 110A); other computer components; or on other software, firmware, or middleware of a system topology. The method 700 can include any or all of steps 710, 720, 730, and/or 740, and it is contemplated that the method 700 includes additional steps as disclosed throughout, but not explicitly set forth in this paragraph. Further, it is fully contemplated that the steps of the method 700 can be performed concurrently, sequentially, or in a non-sequential order. Likewise, it is fully contemplated that the method 700 can be performed prior to, concurrently, subsequent to, or in combination with the performance of one or more steps of one or more other methods or modes disclosed throughout.

Embodiments of the method 700 include a step 710, wherein the step 710 comprises receiving data from at least one optical sensor having at least one field of view. Embodiments of the method 700 also include a step 720, wherein the step 720 comprises performing at least one gesture recognition operation upon receiving data from the at least one optical sensor. Embodiments of the method 700 further include a step 730, wherein the step 730 comprises recognizing an adjust gesture by a particular user of at least one user. The adjust gesture is a touch-less gesture performed in the at least one field of view by the particular user to adjust one or more particular active areas of at least one active area of the at least one field of view. Each of the at least one active area includes a virtual surface or a virtual space within the at least one field of view. Additionally, embodiments of the method 700 include a step 740, wherein the step 740 comprises adjusting the one or more particular active areas in response to recognizing the adjust gesture by the particular user.

It is believed that other embodiments of the invention will be understood by the foregoing description, and it will be apparent that various changes can be made in the form, construction, and arrangement of the components thereof without departing from the scope and spirit of embodiments of the invention or without sacrificing all of its material advantages. The form herein described is merely an explanatory embodiment thereof, and it is the intention of the following claims to encompass and include such changes.

What is claimed is:

1. A method, comprising:
receiving data from at least one sensor having at least one field of view;
performing at least one gesture recognition operation upon receiving data from the at least one sensor having the at least one field of view;
recognizing an adjust gesture by a particular user of at least one user, wherein the adjust gesture is a touch-less gesture performed in the at least one field of view by the particular user to adjust one or more particular active areas of at least one active area of the at least one field of view, wherein each of the at least one active area includes a virtual surface or a virtual space within the at least one field of view; and
adjusting the one or more particular active areas in response to recognizing the adjust gesture by the particular user.

2. The method of claim 1, wherein adjusting the one or more particular active areas in response to recognizing the adjust gesture by the particular user, further comprises:
initiating an active area adjustment mode upon recognizing the adjust gesture by the particular user;
adjusting the one or more particular active areas upon initiating the active area adjustment mode; and
ending the active area adjustment mode.

3. The method of claim 1, wherein adjusting the one or more particular active areas in response to recognizing the adjust gesture by the particular user, further comprises:
initiating an active area adjustment mode upon recognizing the adjust gesture by the particular user;
adjusting the one or more particular active areas upon initiating the active area adjustment mode;
recognizing the completion of the adjust gesture; and
ending the active area adjustment mode upon recognizing the completion of the adjust gesture.

4. The method of claim 1, wherein adjusting the one or more particular active areas in response to recognizing the adjust gesture by the particular user, further comprises:
adjusting at least one of the position, size, orientation, or sensitivity of the one or more particular active areas based upon one or more characteristics of the adjust gesture in response to recognizing the adjust gesture by the particular user.

5. The method of claim 1, wherein receiving data from at least one sensor having at least one field of view, further comprises:
receiving data from at least two sensors having at least one field of view, wherein the at least one field of view includes at least one composite field of view.

6. The method of claim 5, wherein performing at least one gesture recognition operation upon receiving data from the at least one sensor having the at least one field of view further comprises:
performing a cropping algorithm on the data upon receiving the data from the at least two sensors having the at least one field of view, wherein the at least one field of view includes at least one composite field of view.

7. The method of claim 1, further comprising:
indicating via a user feedback mechanism to the particular user in response to recognizing the adjust gesture by the particular user.

8. The method of claim 1, wherein performing at least one gesture recognition operation upon receiving data from the at least one sensor having the at least one field of view further comprises:
performing a cropping algorithm on the data upon receiving the data from the at least one sensor having the at least one field of view.

9. The method of claim 8, wherein performing a cropping algorithm on the data upon receiving the data from the at least one sensor having the at least one field of view further comprises:
cropping out portions of the data from the at least one sensor, wherein the portions of the data correspond to areas of the at least one field of view which are outside of the one or more particular active areas of the at least one active area.

10. The method of claim 9, wherein performing a cropping algorithm on the data upon receiving the data from the at least one sensor having the at least one field of view further comprises:
performing at least one additional gesture recognition operation on portions of the data corresponding to the one or more particular active areas of the at least one active area.

11. The method of claim 9, wherein performing a cropping algorithm on the data upon receiving the data from the at least one sensor having the at least one field of view further comprises:
filtering out spurious gestures of the particular user based upon cropping out portions of the data from the at least one sensor.

12. The method of claim 1, wherein recognizing an adjust gesture by a particular user of at least one user, wherein the adjust gesture is a touch-less gesture performed in the at least one field of view by the particular user to adjust one or more particular active areas of at least one active area of the at least one field of view, wherein each of the at least one active area includes a virtual surface or a virtual space within the at least one field of view further comprises:
recognizing an adjust gesture by a particular user of at least one user, wherein the adjust gesture is a touch-less gesture performed in the at least one field of view by the particular user to adjust at least two particular active areas of at least two active areas of the at least one field of view, wherein each of the at least two active area includes a virtual surface or a virtual space within the at least one field of view, and
wherein adjusting the one or more particular active areas in response to recognizing the adjust gesture by the particular user further comprises:
adjusting the at least two particular active areas in response to recognizing the adjust gesture by the particular user.

13. The method of claim 1, wherein recognizing the adjust gesture by the particular user of the at least one user is implemented by an integrated circuit.

14. A system, comprising:
at least one sensor; and
at least one processor, the at least one processor being configured for:
receiving data from the at least one sensor having at least one field of view;
performing at least one gesture recognition operation upon receiving data from the at least one sensor having the at least one field of view;
recognizing an adjust gesture by a user, wherein the adjust gesture is a touch-less gesture performed in the at least one field of view by the user to adjust an active area of the at least one field of view, wherein the active area includes a virtual surface or a virtual space within the at least one field of view; and
adjusting the active area in response to recognizing the adjust gesture by the user.

15. A device, comprising:
at least one processor, the at least one processor being configured for:
receiving data from at least one optical sensor having at least one field of view;
performing at least one gesture recognition operation upon receiving data from the at least one optical sensor having the at least one field of view;
recognizing an adjust gesture by a particular user of at least one user, wherein the adjust gesture is a touch-less gesture performed in the at least one field of view by the particular user to adjust one or more particular active areas of at least one active area of the at least one field of view, wherein each of the at least one active area includes a virtual surface or a virtual space within the at least one field of view; and
adjusting the one or more particular active areas in response to recognizing the adjust gesture by the particular user.

16. The device of claim 15, wherein the at least one processor is further configured for:
initiating an active area adjustment mode upon recognizing the adjust gesture by the particular user;
adjusting the one or more particular active areas upon initiating the active area adjustment mode; and
ending the active area adjustment mode.

17. The device of claim 15, wherein the at least one processor is further configured for:
performing a cropping algorithm on the data upon receiving the data from the at least one optical sensor having the at least one field of view.

18. The device of claim 17, wherein the at least one processor is further configured for:
cropping out portions of the data from the at least one optical sensor, wherein the portions of the data correspond to areas of the at least one field of view which are outside of the one or more particular active areas of the at least one active area.

19. The device of claim 18, wherein the at least one processor is further configured for:
performing at least one additional gesture recognition operation on portions of the data corresponding to the one or more particular active areas of the at least one active area.

20. The device of claim 15, wherein the at least one processor is further configured for:
filtering out spurious gestures of the particular user.
